(19) United States
(12) Patent Application Publication
(10) Pub. No.: US 2026/0103136 A1
(43) Pub. Date: Apr. 16, 2026

(54) TRAILER-BASED COMPRESSED AIR PARTICULATE REMOVAL SYSTEM

(71) Applicant: MAXXIM INDUSTRIES USA II, LLC, Houston, TX (US)

(72) Inventors: Christopher Alexander de la Mora, Houston, TX (US); Ronnie Campbell Manning, JR., Houston, TX (US)

(21) Appl. No.: 19/354,010

(22) Filed: Oct. 9, 2025

Related U.S. Application Data
(60) Provisional application No. 63/706,399, filed on Oct. 11, 2024.

(51) Int. Cl. B60P 1/60; B60P 1/56; B60R 16/08; B60T 15/00; B60T 17/06; B65D 88/72

(52) U.S. Cl. CPC B60P 1/60; B60P 1/56; B60R 16/08; B60T 15/00; B60T 17/06; B65D 88/72

(57) ABSTRACT

A method for flowing sand out of a trailer, includes charging a brake air tank of the trailer. The method further includes charging an air compression tank with air from the brake air tank. Additionally, the method includes opening a gate of a hopper attached to the trailer, so sand flows out an opening formed by the gate. Moreover, the method includes activating a first air nozzle on the hopper to emit a burst of air from the air compression tank after a first set time period to assist moving the sand. Also, the method includes activating a second air nozzle on the hopper to emit a burst of air from the air compression tank after a second set time period to assist moving the sand. Further, the method includes repeatedly reactivating the first air nozzle and the second air nozzle until the air compression tank is empty.

### CROSS-REFERENCE TO RELATED APPLICATIONS

This application claims the benefit of U.S. Provisional Application No. 63/706,399, filed on Oct. 11, 2024, and titled “TRAILER-BASED COMPRESSED AIR PARTICULATE REMOVAL SYSTEM.” U.S. Provisional Application No. 63/706,399 is hereby incorporated herein by reference.

### BACKGROUND

Aggregates and particulates such as sand can be used in a wide variety of processes such as fracking for fracturing a shale layer. Transporting the sand from one location to another can be a burdensome and costly endeavor due to the amount of sand and the difficulty in removing it from transportation volumes.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a perspective view of a trailer system in accordance with one or more embodiments.

FIG. 2 shows a top view of a trailer system in accordance with one or more embodiments.

FIG. 3 shows a bottom view of a trailer system in accordance with one or more embodiments.

FIG. 4 shows a side view of a trailer system in accordance with one or more embodiments.

FIG. 5 shows a top view of a trailer system without a roof in accordance with one or more embodiments.

FIG. 6 shows a portion of a side view of a trailer system without a side panel in accordance with one or more embodiments.

FIG. 7 shows a flowchart of a method of charging and using air nozzles in a hopper in accordance with one or more embodiments.

### DETAILED DESCRIPTION

In the below description, numerous details are set forth as examples of embodiments described herein. It will be understood by those skilled in the art, and having the benefit of this Detailed Description that one or more embodiments described herein may be practiced without these specific details and that numerous variations or modifications may be possible without departing from the scope of the embodiments described herein. Certain details known to those of ordinary skill in the art may be omitted to avoid obscuring the description.

One challenge of handling fracking sand, or other aggregates that are transported in trailers in a traditional manner, is removing the sand from trailers to be used at well sites quickly and efficiently. Due to the density and volume of fracking sand needed at remote sites, large amounts of sand by volume and weight are needed at oil and gas well sites which may be spread out over great distances. To move the sand, trailers are used for transportation. Once at the well sites, the sand must be removed from the trailers. Hoppers are attached to the bottom of the trailers and the sand is moved out the bottom of the hoppers via gravity. Without other aids, gravity can take too long to remove the sand. In the case of high percentage moisture sand, gravity may not be able to remove all the sand from the trailer, which may clump. This would require human intervention to remove the sand out of the trailer, wasting time and expending operation resources. For at least the reasons discussed above, different trailers for transporting sand and approaches for removing sand from the trailers may be beneficial.

In general, embodiments disclosed herein provide a trailer system that that has air nozzles disposed on the hopper and an associated method to assist in removing the sand. The nozzles are disposed on the hopper in a specific formation and fire air blasts after specific time periods to remove the sand. Further, various embodiments disclosed herein provide for the interior to be set at specific angles and a container inside the trailer to have a liner to assist removing sand.

The following describes various embodiments disclosed herein.

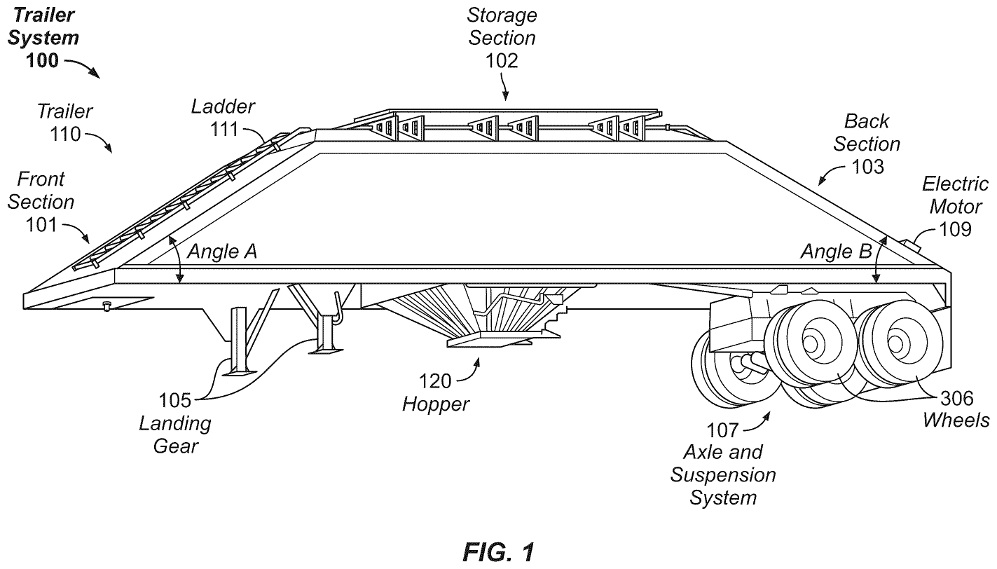

FIG. 1 shows a perspective view of a trailer system (100) in accordance with one or more embodiments. The trailer system (100) includes a trailer (110) that is configured to receive and hold aggregates, particulates, and/or granular material (collectively referred to as granular material or sand), such as sand, for oil extracting processes (e.g., a fracking process). The trailer system (100) may be used to transport aggregates, particulates, and/or granular material for other purposes without departing from the embodiments. A hopper (120) is connected to a bottom surface of the trailer (110) and is described in the following figures.

Generally, the trailer (110) may be logically split into three sections, a front section (101), a storage section (102), and a back section (103). In one or more embodiments, the front section (101) includes the portions of the trailer (110) used for coupling to another object, such as a truck, dolly, or another trailer, such as a hitch (not shown). The hitch includes functionality to connect to a vehicle, such as a tractor trailer or other similar trailer hauling vehicle, to transport the trailer. The hitch may include a standard king pin to perform any coupling. The front section (101) includes a landing gear (105) to allow the trailer (110) to be securely flat when not connected to another object. The landing gear (105) include the functionality to retract when the trailer (110) is in transit. In one or more embodiments, the storage section (102) includes the portions of the trailer (110) used for receiving, storing, and dispensing the granular material. The storage section (102) includes the hopper (120). In one or more embodiments, the back section (103) includes the portions of the trailer (110) used for coupling to other objects, such as a dolly or another trailer. The back section (103) further includes an axle and a suspension system (107). Each of the front section (101), the storage section (102), and the back section (103) are described in greater detail below.

The trailer system (100) may have a gross vehicle weight rating of 32, 35, or 40 tons or any rating between 32 and 40 tons. The rating is the total weight of the trailer and any contents contained therein, such as fracking sand. Thus, a trailer rated for 35 tons can weigh up to 35 tons while remaining within the limits specified by the manufacturer. Further, to accommodate such a weight, the height of the trailer (110) from the bottom rail to the top of the trailer may be 78, 84, 90, or 96 inches tall, or any height between 78 and 96 inches. The trailer system is not limited to the aforementioned dimensions.

In addition, many jurisdictions have rules regarding the amount of weight carried by each axle of a vehicle driven on public roads. In the current embodiment, the axle and suspension system (107) include two axles in the back section (103) and the front section (101) may couple to an object (e.g., vehicle) having two or more axles, thereby providing four axles to support the weight of the trailer (110). In one or more embodiments, the trailer (110) may include more axles to comply with alternative rules and/or provide additional support.

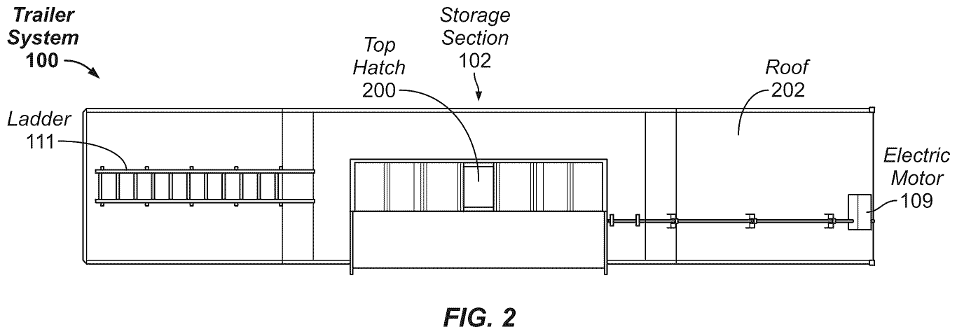

Further, an angle A formed at the front section (101) and an angle B the back section (103) of the trailer (110) may be 30, 35, or 40 degrees or any angle between 30 and 40 degrees. In one or more embodiments, the angle A for the front section (101) is equivalent to the angle B for the back section (103). In one or more embodiments, the angles for the front section (101) and the back section (103) are different values. The generally trapezoidal side cross-section of the trailer (110) provides additional strength, particularly to the side walls of the trailer (110), thereby enabling a greater load of product (e.g., fracking sand) in the trailer, particularly due to the stopping and starting of the trailer (110). The embodiments is not limited to the values of angle A and angle B included above. The trailer (110) includes a top hatch described with FIG. 2 that allows sand to be loaded into the trailer (110).

Further, the trailer (110) may include a combination of materials as described below. For example, the trailer (110) may include some lower strength but lighter materials (e.g., aluminum) and some higher strength but heavier materials (e.g., steel) to provide a lower overall weight while also maintaining strength sufficient to hold large loads. The steel may be used for critical structural components of the trailer (110) such as the landing gear (105), the hopper (120), and the frame of the trailer (110). The trailer (110) may be constructed out of any combination of materials without departing from the embodiments. The trailer (110) may include additional components required to allow the trailer (110) to be transported on public roads such as taillights (not shown) and turn signals (not shown). The trailer (110) may include additional elements without departing from the disclosure.

FIG. 2 shows a top view of the trailer system (100) in accordance with one or more embodiments. The top view displays a roof of the trailer (110). FIG. 2 shows a top hatch (200) where the trailer system (100) can be filled with sand. The top hatch (200) is disposed in a center of a roof (202) of the trailer (110) of the storage section (102). The top hatch (200) may be disposed at another location on the roof (202) without departing from the embodiments. The top hatch (200) is configured to allow sand to be disposed into the trailer (110). The top hatch may be opened to allow sand into the trailer (110) (e.g., during loading) and closed (e.g., when the sand is being transported or released through the hopper (120)) to avoid sand exiting through the top hatch (200). The top hatch may be electronically operated by an electric motor (109). In one or more embodiments, the top hatch (200) may be opened manually by a crank (not shown). The top hatch (200) may be rectangular in shape and have dimensions of about 30 inches by about 150 inches. In one or more embodiments, the top hatch (200) may have different dimensions. The top hatch (200) may open by sliding open electronically or manually. A ladder (111) may be present on the trailer (110) (e.g., on the front section (101)) to allow maintenance on the roof (202) and the top hatch (200).

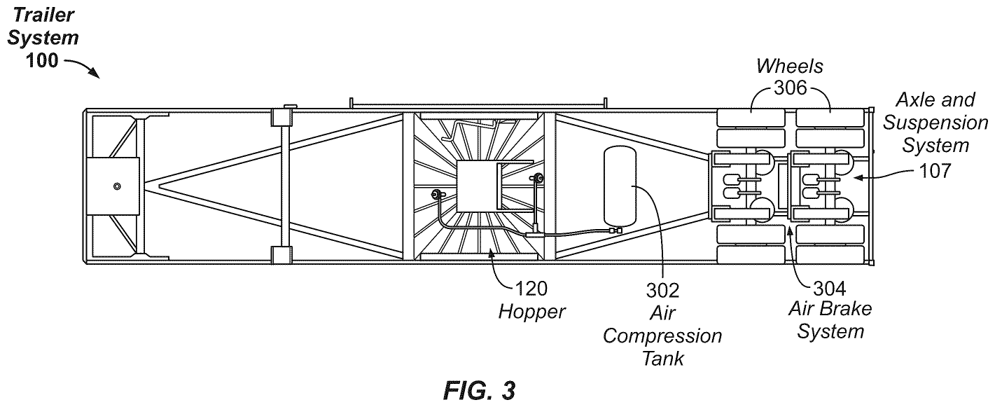

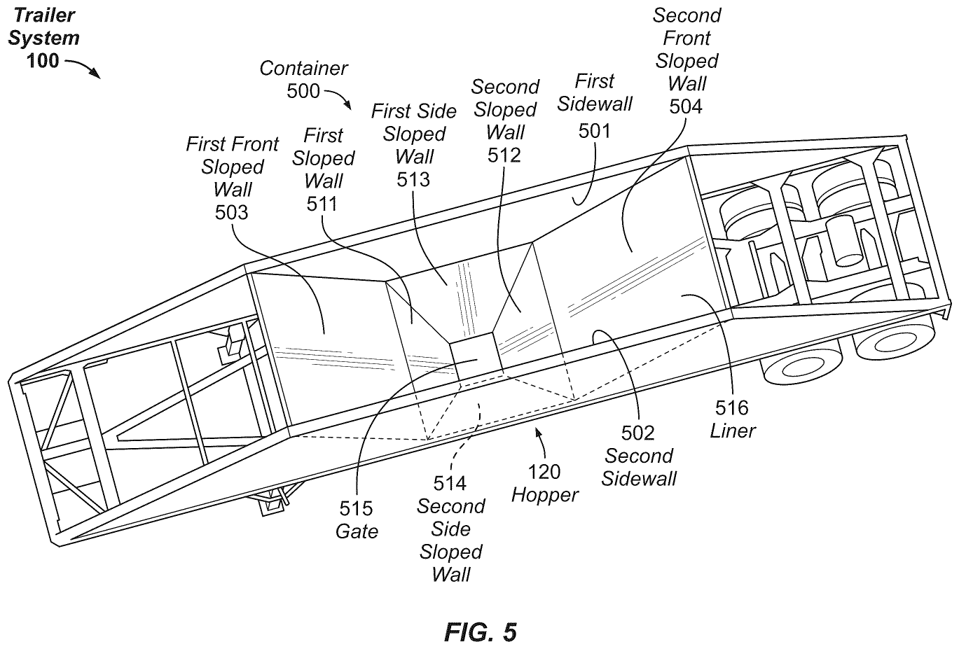

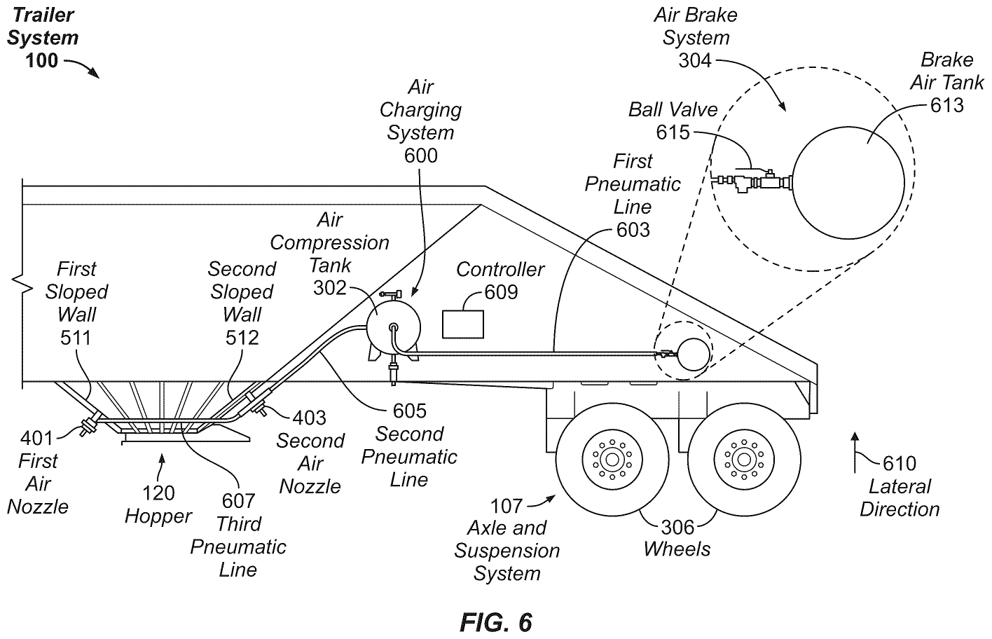

FIG. 3 shows a bottom view of a trailer system (100) in accordance with one or more embodiments. FIG. 3 shows a bottom surface of the trailer (110) including a bottom of the hopper (120), an air compression tank (302), and an air brake system (304) of the axle and suspension system (107). The air brake system (304) is a pneumatic system to apply braking force to wheels (306) of the axle and suspension system (107) to stop movement of the trailer (110). The air brake system (304) is configured to provide air to the air compression tank (302). The air brake system (304) and the air compression tank (302) are described in FIG. 6. In one or more embodiments, as shown in FIG. 3, the air compression tank (302) is connected to the bottom surface of the trailer (110). The hopper (120) includes a gate (515) described with FIG. 5. One or more hitches can be present on the bottom surface to connect the trailer (110) to other trailers as discussed with FIG. 1. Structural supports shown in FIG. 3 may be used on the bottom surface of the trailer (110) to provide structural support to the bottom surface of the trailer (110) due to the weight of the trailer (110) and the weight of the sand to be disposed into the trailer (110). These structural supports may be present on the hopper (120) to provide support. As shown in FIG. 3, the trailer (110) includes eight wheels (306) in two sets with an axle each. The first set is four wheels connected by a first axle; two wheels connected to each other on either side of the trailer (110). The second set is four wheels connected by a second axle; two wheels connected to each other on either side of the trailer (110). In one or more embodiments, additional or fewer wheels may be present in the axle and suspension system (107). The wheels (306) allow movement of the trailer (110).

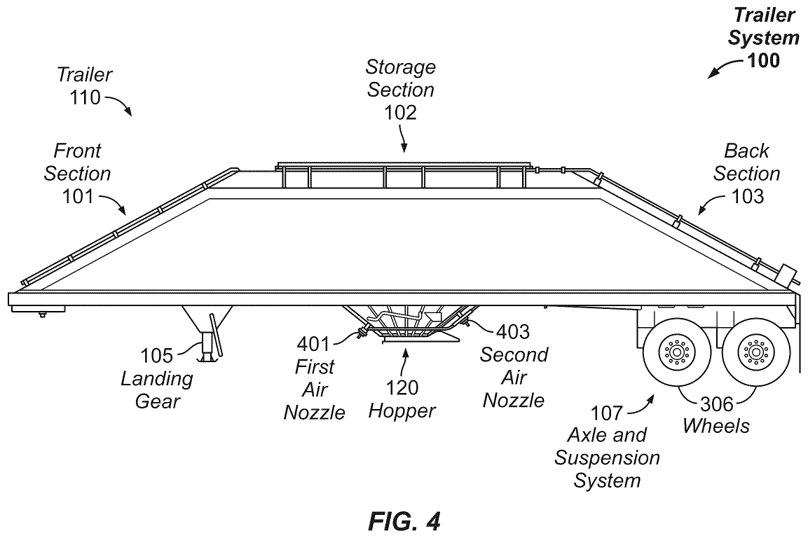

FIG. 4 shows a side view of the trailer system (100) in accordance with one or more embodiments. FIG. 4 shows the trailer system (100), the trailer (110), the hopper (120), the landing gear (105), the axle and suspension system (107), the front section (101), the storage section (102), and the back section (103) as shown in FIG. 1. FIG. 4 shows a first air nozzle (401) and a second air nozzle (403) positioned on opposite sides of the hopper (120) offset a vertical distance. The first air nozzle (401) and the second air nozzle (403) are disposed on walls of the hopper (120). The first air nozzle (401) and the second air nozzle (403) are connected to the air compression tank (302) as described in FIG. 6. In one or more embodiments, additional or fewer air nozzles may be positioned on the hopper (120). The axle and suspension system (107) includes the wheels (306). The wheels (306) might be aluminum wheels with a diameter of about 22.5 inches. The trailer system is not limited to the aforementioned dimensions.

FIG. 5 shows a top view of a trailer system without the roof (202) in accordance with one or more embodiments. For purposes of illustration, the roof (202) present in FIG. 2 is removed to allow a view of a container (500) for holding the sand in the trailer (110). The container (500) includes a first sidewall (501), a second sidewall (502), a first front sloped wall (503), a second front sloped wall (504), and the hopper (120). The hopper (120) is at the bottom of the container (500) and includes a volume that is a part of the container (500). The hopper (120) includes a first sloped wall (511), a second sloped wall (512), a first side sloped wall (513), a second side sloped wall (514), and a gate (515). The gate (515) is a bottom of the hopper (120). The gate (515) can be opened to allow the sand to exit the container (500) (e.g., sand flows out of the trailer (110)). The gate (515) may be connected to an electric motor (not shown) and opened automatically to release sand. In one or more embodiments, the gate (515) may be connected to a manual crack (not shown) and manually opened to release sand.

In one or more embodiments, the first front sloped wall (503), the second front sloped wall (504), the first sloped wall (511), the second sloped wall (512), the first side sloped wall (513), and the second side sloped wall (514) have surfaces with a liner (516). The liner (516) assists in moving the sand out of the container (500) through an opening in the gate (515). The liner (516) may include ultra-high molecular weight polyethylene (e.g., UHMW plastic). The liner (516) may have a thickness of about 0.25 inches. The first sidewall (501) and the second sidewall (502) do not have the liner (516). In one or more embodiments, the liner (516) has a surface area of about 220.7 ft. In one or more embodiments, none of the walls include a liner. The trailer system is not limited to the aforementioned dimensions.

The first sidewall (501) and the second sidewall (502) are at about 90 degree angles relative to a bottom surface of the trailer system (100). The first front sloped wall (503) and the second front sloped wall (504) are between 35 degrees and 45 degrees such as a 39 degree angle with the bottom surface of the trailer system (100). The first sloped wall (511) and the second sloped wall (512) are angled between 35 to 42 degrees, such as 38.9 degrees with the bottom surface of the trailer (110). The first side sloped wall (513), and the second side sloped wall (514) are angled between 32 and 38 degrees, such as 35.0 degrees with the bottom surface of the trailer (110). The gate (515) is substantially parallel with the bottom surface of the trailer system (100). The embodiments are not limited to the angles specified above.

FIG. 6 shows a portion of a side view of a trailer system without the side panel in accordance with one or more embodiments. For purposes of illustration, the side panel visible in FIGS. 1 and 4 is removed to allow visibility on an air charging system (600). FIG. 6 shows the air charging system (600) for the first air nozzle (401) and the second air nozzle (403). In one or more embodiments, only a first air nozzle (401) is implemented with no second air nozzle (403) present. The first air nozzle (401) is shown positioned on the first sloped wall (511) and the second air nozzle (403) is shown positioned on the second sloped wall (512). The first air nozzle (401) and/or second air nozzle (403) are positioned such that air that is emitted from the aforementioned nozzles into the hopper (120). Accordingly, the nozzles pass through the side walls (503, 504) and any liner (516) to allow the air that is emitted from the air compression tank (302) to reach the internal volume of the hopper (120) and to come in contact with any sand (or aggregates) that are present in the hopper (120).

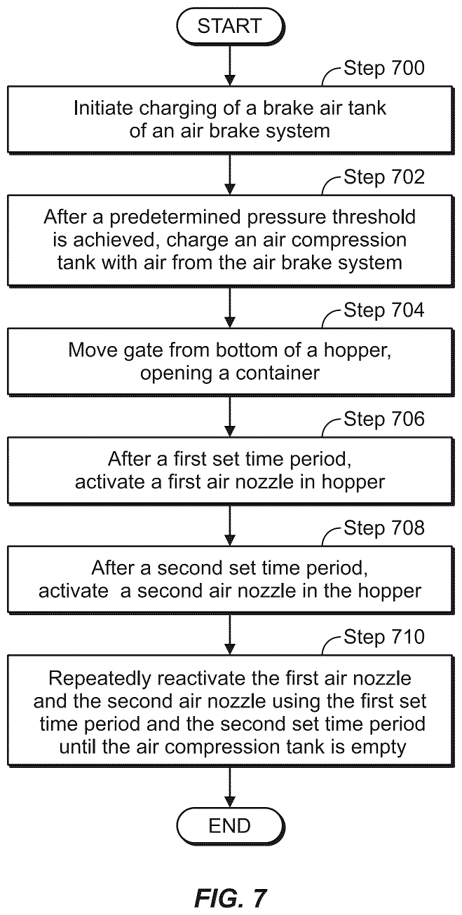

Continuing with the discussion of FIG. 6, the first air nozzle (401) and the second air nozzle (403) may be offset in a lateral direction (610). For example, the first air nozzle (401) may be positioned about 1 ft. from the bottom of the first sloped wall (511) (e.g., bottom of the hopper (120)) (about 0.63 ft. in the lateral direction (610) from the bottom of the first sloped wall) and the second air nozzle (403) may be positioned about 2 ft. from the bottom of the second sloped wall (513) (about 1.26 ft. in the lateral direction (610) from the bottom of the first sloped wall). Therefore, the second air nozzle (403) is offset 0.63 ft. in the lateral direction (610) above the first air nozzle (401). In one or more embodiments, the first air nozzle (401) and the second air nozzle (403) are not offset in the lateral direction (610) and are at the same height in the lateral direction (610). The first air nozzle (401) and the second air nozzle (403) are operable to emit a burst(s) of air into the hopper (120) as described in the method of FIG. 7. The embodiments are not limited to the positioning and/or relative positioning of the air nozzles described above. The first air nozzle (401) and the second air nozzle (403) may include a high flow diaphragm valve to emit the burst of air. In one or more embodiments, the first air nozzle (401) is on the side of the hopper (120) near the front of the trailer (110) and the second air nozzle (403) is on the side of the hopper (120) near the back of the trailer (110).

The air charging system (600) connects to the air brake system (304). The air charging system (600) includes the air compression tank (302), a first pneumatic line (603), a second pneumatic line (605), a third pneumatic line (607), and a controller (609). The first pneumatic line (603) connects the air compression tank (302) with the air brake system (304). The first pneumatic line (603) may comprise nylon tubing. The second pneumatic line (605) connects the air compression tank (302) with the second air nozzle (403). The third pneumatic line (607) connects the air compression tank (302) with the first air nozzle (401). The second pneumatic line (605) and the third pneumatic line (607) may comprise a flexible hose with an internal diameter of about 1.5 inches. Air can travel from the pneumatic lines to the first air nozzle (401) and the second air nozzle (403) to be emitted as a burst into the hopper (120). In one or more embodiments, as shown in FIG. 6, the air compression tank (302) is present in the trailer (110) in the back section (103). The controller (609) is operatively connected to the first air nozzle (401) and the second air nozzle (403). In one or more embodiments, the controller (609) may be physically connected to an interior surface of the side panel inside the trailer (110). The controller (609) communicates with the first air nozzle (401) and the second air nozzle (403) to control the activation of the first air nozzle (401) and the second air nozzle (403) to emit a burst of air in set time periods as described in FIG. 7. The controller (609) may be a time sequence controller with a power source (not shown) (e.g., a 12-volt source).

The air brake system (304) in the trailer system is a safety-critical pneumatic braking system that uses compressed air to transmit and apply braking force to the trailer's wheels (306). The air brake system (304) includes a brake air tank (613) and various valves and hoses (shown) to the trailer brakes (not shown). When the driver applies the brakes in the truck (that is towing the trailer, not shown), compressed air flows through these valves and hoses to activate the trailer's brakes, ensuring synchronized braking between the truck and the trailer system (100). The air brake system is designed with fail-safe features such that a loss of air pressure automatically engages the trailer's spring brakes, preventing uncontrolled movement and enhancing overall road safety.

The air brake system (304) further includes ball valve (615). The brake air tank (613) is connected to an air system (not shown) of the trailer, which charges the brake air tank (613) to a predetermined pressure threshold. In the context of an air brake system, “charging” or “to charge” a brake air tank refers to the process of directing and accumulating compressed air from a compressor (not shown) into the brake air tank (613) until the desired pressure level is reached. The predetermined pressure threshold may be (but is not limited to) about 90 psi. The ball valve (615) is positioned on the first pneumatic line (603) between the brake air tank (613) and the air compression tank (302). Once the predetermined pressure threshold in reached in the brake air tank (613), the ball valve (615) allows for air to move through the first pneumatic line (603) to charge the air compression tank (302). The air compression tank (302) may have a capacity of about, e.g., 60 gallons of air (e.g., 13860 cubic inches). The ball valve (615) is designed to be closed while the brake air tank (613) is charged and to prevent air from passing through when it would cause the pressure in the brake air tank (613) to fall below the predetermined pressure threshold (e.g., cause a loss in pressure in the brake lines). The brake air tank (613) is also connected to brakes (not shown) on the wheels (306) of the axle and suspension system (107) to provide anti-lock braking for the trailer (110). The brake air tank (613) may have a capacity of, e.g., about 3000 cubic inches. The disclosure is not limited to the aforementioned dimensions.

Turning to FIG. 7, FIG. 7 shows a flowchart for a method of charging and using the first air nozzle and the second air nozzle in the hopper in accordance with one or more embodiments disclosed herein. The method of FIG. 7 may be performed by, for example, the controller (e.g., 609, FIG. 6). Other components of the trailer system (e.g., 100, FIG. 1) of FIGS. 1-6 may perform all, or a portion, of the method of FIG. 7 without departing from the disclosure.

While the various steps in the flowchart of FIG. 7 are presented and described sequentially, one of ordinary skill in the relevant art will appreciate that some or all of the steps may be executed in different orders, may be combined, or omitted, and some or all steps may be executed in parallel.

In step 700, a brake air tank (e.g., 613, FIG. 6) of an air brake system (e.g., 304, FIG. 3.) is charged (e.g., filled) with air. The brake air tank is charged to a predetermined pressure threshold. The brake air tank is charged using an air system of a trailer (e.g., 110, FIG. 1) to which the air brake system is attached. In one or more embodiments, the controller controls the charging of the brake air tank. In one or more embodiments, a separate controller controls the charging of the brake air tank. The trailer includes a container filled with granular material. In one embodiment, air brake system must charge the brake air tank prior to the trailer being moved. The trailer may be connected to a vehicle (e.g., a truck, a semi-truck, etc.) to transport the trailer. Said another way, for safety reasons, the air brake system must charge (e.g., pressurize) the brake air tank prior to semi-truck moving the trailer to ensure the brakes will be active prior to movement. If the brake air tank is not charged, then the air brakes on the trailer will not work and the semi-truck (connected to the trailer) may not be able to safely stop the trailer.

In step 702, an air compression tank (e.g., 302, FIG. 3) is charged with air from the brake air tank after a predetermined pressure threshold is achieved in the brake air tank. Once the predetermine pressure threshold, which is necessary to operate the brakes of the trailer, is reached, a ball valve (e.g., 615, FIG. 6) on a first pneumatic line (e.g., 603, FIG. 6) is opened; allowing air from the brake air tank to move through the first pneumatic line to charge the air compression tank. In one or more embodiments, the predetermined pressure threshold is 90 psi. In one or more embodiments, the air compression tank may be filled with air leveraging the same air compression system as the air brake system. In this manner, the air compression tank can be pressurized without requiring the addition of another compressor. Further, by including the ball valve, the pressure in the brake air tank may be maintained for braking, while also allowing the air compression tank to be pressurized. Once the air compression tank reaches a set pressure for use with the air nozzles, the controller (or separate controller) may deactivate the air charging system of the trailer. In one or more embodiments, the air compression tank may be charged with air while the trailer is in transit (i.e., moving) towards its intended destination (e.g., a fracking site).

In step 704, a gate (e.g., 515, FIG. 5) at a bottom surface of a hopper (e.g., 120, FIG. 2) is moved to an open position. Step 704 may be performed at any time after the air compression tank reaches the set pressure. In one or more embodiments, the air compression tank is charged, the trailer is driven to an oil and gas well site and then the gate is opened. The hopper is a bottom portion of the container (e.g., 500, FIG. 5) of the trailer. Opening the gate allows for sand to flow out of the container. The gate has a contact switch which is activated when the gate is opened. The contact switch signals to the controller that the gate is opened. In one or more embodiments, the controller sends the signal for the gate to electronically open with a motor. In one or more embodiments, the gate is opened manually with a crank.

In step 706, a first air nozzle (e.g., 401, FIG. 4) disposed in the hopper is activated (e.g., when the gate is opened) and emits a burst of air after a first set time period. The controller activates the first air nozzle after the first set time period, which is first measured from when the gate is opened and subsequently measured from the previous emission from the second air nozzle. The first set time period may be (but is not limited to) about three seconds. The first time period may be repeated for repeated emissions of air from the first air nozzle as described in Step 710.

When there is a second nozzle, then in step 708, a second air nozzle (e.g., 403, FIG. 4) disposed in the hopper is activated after a second set time period. The controller activates the second air nozzle after the second set time period, which is first measured from when the gate is opened and subsequently measured from the previous emission from the second air nozzle. The second set time period may be (but is not limited to) about seven seconds. In one or more embodiments, first set time period and the second set time period are equal and the first air nozzle and the second air nozzle are activated at the same time (or at substantially the same time). The second time period may be repeated for repeated emissions of air from the second air nozzle as described in Step 710.

In step 710, the first air nozzle and the second air nozzle (if present) are repeatedly reactivated using the first set time period and the second set time period until the air compression tank is empty. The first air nozzle is activated after the first time set time period measured from the last activation of the second air nozzle. The second air nozzle is activated after the second time period measured from the last activation of the second air nozzle.

For example, the gate is activated starting at time zero. The first air nozzle emits air at time one (three seconds after time zero). The second air nozzle emits air at time three (seven seconds after time zero). The first air nozzle then emits air at time four (10 seconds after time zero). The second air nozzle then emits air at time five (14 seconds after time zero). The first air nozzle then emits air at time six (17 seconds after time zero). The second air nozzle then emits air at time seven (21 seconds after time zero). This repeats until the air compression tank is empty.

In one or more embodiments, where the first air nozzle and the second air nozzle are activated at the same time, the first air nozzle and the second air nozzle are reactivated at the same time.

The described method above reduces the amount of time to unload a trailer of an aggregate such as sand. Without the design of the trailer system (e.g. 100, FIGS. 1-6) and the method of FIG. 7, unloading between 25 tons to 35 tons of sand may take between 4 to 6 minutes depending on the moisture content of the sand. At higher moisture levels, operator assistance may be needed to empty the trailer. The embodiments of the disclosure reduce the time needed to unload between 25 tons to 35 tons of sand to between 1:30 to 2 minutes depending on the moisture level. These times have been shown for sand from 4% to 18% moisture content.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

As used herein, “about” is used to demonstrate that the given value includes a small range of values both greater than and less than the given value (e.g., there exists a range of values contemplated that would satisfy by the given value). This range is meant to extend 15% above and below the given value. For example, about 100 would mean between 85 and 115.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for flowing sand out of a container, comprising:
charging a brake air tank of an air brake system of a trailer, the trailer comprising a container filled with sand;
charging an air compression tank with air from the air brake system after a predetermined pressure threshold is achieved in the brake air tank;
moving a gate on a bottom surface of a hopper to an open position, wherein the hopper is positioned on a bottom of the container and sand flows out an opening formed by the gate;
activating a first air nozzle to emit a burst of air from the air compression tank after a first set time period following the moving of the gate, wherein the first air nozzle is positioned on the hopper and configured to assist moving the sand out of the opening;
activating a second air nozzle to emit a burst of air from the air compression tank after a second set time period, wherein the second air nozzle is positioned on the hopper and configured to assist moving the sand out of the opening; and
repeatedly reactivating the first air nozzle and the second air nozzle at the first set time period and the second set time period until the air compression tank is empty.

2. The method of claim 1, wherein a ball valve is positioned on a pneumatic line connecting the brake air tank and the air compression tank, wherein the ball valve prevents the brake air tank from falling under the predetermined pressure threshold while the air compression tank is charging and emptied by the first air nozzle and the second air nozzle.

3. The method of claim 1, wherein the first air nozzle and second air nozzle are positioned on opposite sides of the hopper and the second air nozzle is offset in a lateral direction from the first air nozzle.

4. The method of claim 3, wherein the second air nozzle is offset between 0.5 ft. and 1 ft. above the first air nozzle in the lateral direction.

5. The method of claim 1, wherein the first set time period and the second set time period are equal and the first air nozzle and the second air nozzle are activated at the same time.

6. The method of claim 1, wherein the first air nozzle is activated before the second air nozzle.

7. The method of claim 6, wherein the first set time period is 3 seconds, and the second set time period is 7 seconds.

8. The method of claim 1, wherein between 25 tons and 35 tons of the sand with a moisture content of between 4% and 18% can be removed from the container in between 1:30 to 2 minutes.

9. A method for flowing sand out of a container, comprising:
charging a brake air tank of an air brake system of a trailer, the trailer comprising a container filled with sand;
charging an air compression tank with air from the air brake system after a predetermined pressure is achieved in the brake air tank, wherein the charging of the air compression tank may occur while the trailer is in transit;
moving, after charging of the air compression tank is completed, a gate on a bottom surface of a hopper to an open position, wherein the hopper is positioned on a bottom of the container and sand flows out an opening formed by the gate; and
activating a first air nozzle to emit a burst of air from the air compression tank after a first set time period wherein the first air nozzle is positioned on the hopper and configured to assist moving the sand out of the opening.

10. The method of claim 9, further comprising:
activating a second air nozzle to emit a burst of air from the air compression tank after a second set time period, wherein the second air nozzle is positioned on the hopper and configured to assist moving the sand out of the opening.

11. The method of claim 10, wherein the first air nozzle and second air nozzle are positioned on opposite sides of the hopper and the second air nozzle is offset in a lateral direction from the first air nozzle.

12. The method of claim 11, wherein the second air nozzle is offset between 0.5 ft. and 1 ft. above the first air nozzle in the lateral direction.

13. The method of claim 10, wherein the first set time period is 3 seconds, and the second set time period is 7 seconds.

14. A trailer, comprising:
a brake air tank connected to an air brake system of the trailer, the brake air tank operable to fill with air to operate air brakes of the trailer;
a ball valve connected to the brake air tank via a first pneumatic line, the ball valve operable to prevent a loss of pressure in the brake air tank from falling below a predetermined pressure threshold;
an air compression tank connected to the ball valve via the first pneumatic line and configured to fill with air provided via the first pneumatic line after the brake air tank at least equal to the predetermined pressure threshold; and
a first air nozzle connected to the air compression tank via a second pneumatic line, the first air nozzle disposed on a hopper, wherein the hopper is disposed at a bottom of a container disposed in the trailer and configured to granular material.

15. The system of claim 14, further comprising:
a gate disposed at a bottom surface of the hopper configured to allow granular material to exit the trailer when open;
a contact switch disposed on the gate configured to communicate with a controller when the gate is opened; and
the controller configured to communicate to the first air nozzle to emit a burst of air after a first set time period when the gate is opened.

16. The system of claim 15, further comprising:
a second air nozzle disposed on the hopper, wherein:
the second air nozzle is connected to the air compression tank via a third pneumatic line, and
the controller configured to communicate to the second air nozzle to emit a second burst of air after a second set time period after the first air nozzle emits the burst of air.

17. The system of claim 16, wherein the first air nozzle and second air nozzle are positioned at the same height on opposite sides of the hopper.

18. The system of claim 16, wherein the first air nozzle and second air nozzle are positioned on opposite sides of the hopper and the second air nozzle is offset in a lateral direction from the first air nozzle.

19. The system of claim 18, wherein the second air nozzle is offset between 0.5 ft. and 1 ft. above the first air nozzle in the lateral direction.

20. The system of claim 16, wherein the first air nozzle and the second air nozzle are disposed on walls of the hopper, the walls of the hopper at between 30 degrees and 40 degrees parallel with a bottom surface of the trailer.
